(19) United States
(12) Patent Application Publication
(10) Pub. No.: US 2014/0035996 A1
(43) Pub. Date: Feb. 6, 2014

(54) PRINT HEAD SERVICING UNITS AND METHODS

(71) Applicants: Xavier GROS GRAS, Barcelona (ES); Emilio Angulo Navarro, Barcelona (ES); Marta Coma Vives, Barcelona (ES); Ainhoa Urbistondo Galarraga, Barcelona (ES)

(72) Inventors: Xavier GROS GRAS, Barcelona (ES); Emilio Angulo Navarro, Barcelona (ES); Marta Coma Vives, Barcelona (ES); Ainhoa Urbistondo Galarraga, Barcelona (ES)

(21) Appl. No.: 13/562,530

(22) Filed: Jul. 31, 2012

(51) Int. Cl. B41J 2/165

(52) U.S. Cl. 347/33

(57) ABSTRACT

A print head servicing unit comprises a cassette which is removably insertable in a hard copy apparatus and comprises some or all of a moveable web of absorbent colour material for receiving waste ink from the print head; a storage compartment for accommodating received waste ink; a cap for the print head; and a filter for filtering air-borne particles in the region of the print head. The path of the web through the cassette is such that a region thereof for receiving spat ink from the print head is arranged downstream of a region thereof for wiping ink from the print head.

### BACKGROUND

Hard copy devices have print heads which require frequent servicing operations to be performed upon them. These operations use different components which are replaced at intervals as waste products accumulate.

### BRIEF DESCRIPTION OF THE DRAWINGS

FIG. 1 is a side sectional view of a print head servicing unit in accordance with an embodiment;

FIG. 2 is a perspective view of the unit of FIG. 1;

FIG. 3 is a perspective view of a hard copy device in the form of a printer in which servicing units in accordance with embodiments may be employed; and

FIG. 4 is a view corresponding to FIG. 3 with an inserted servicing unit in the form of a cassette.

### DETAILED DESCRIPTION OF THE EMBODIMENTS

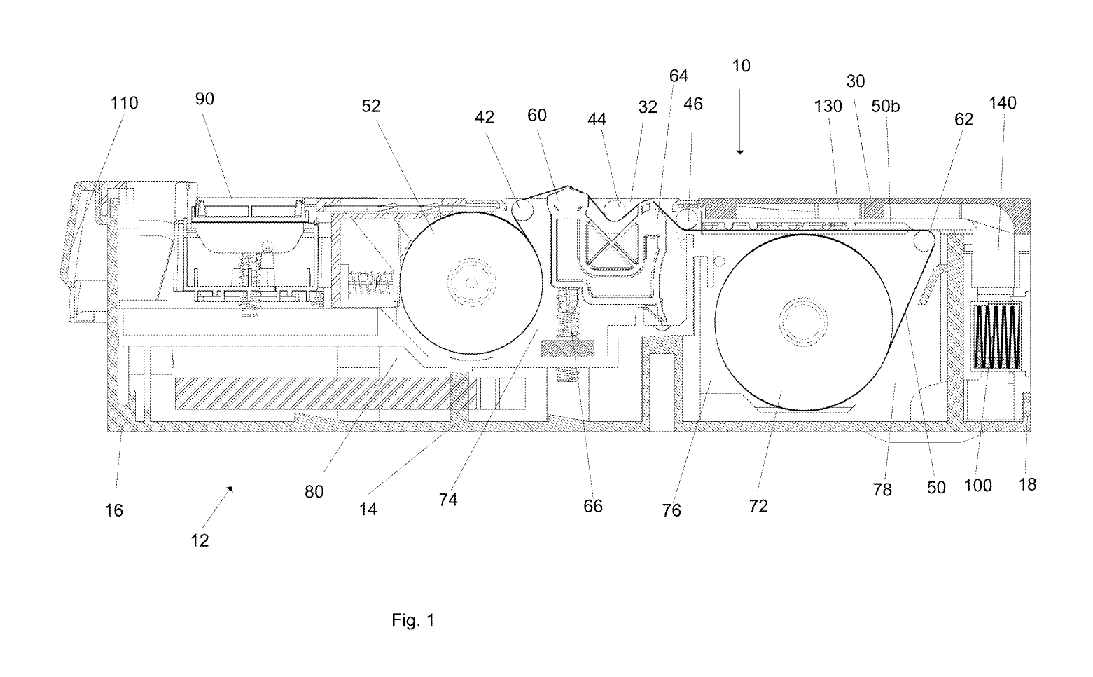

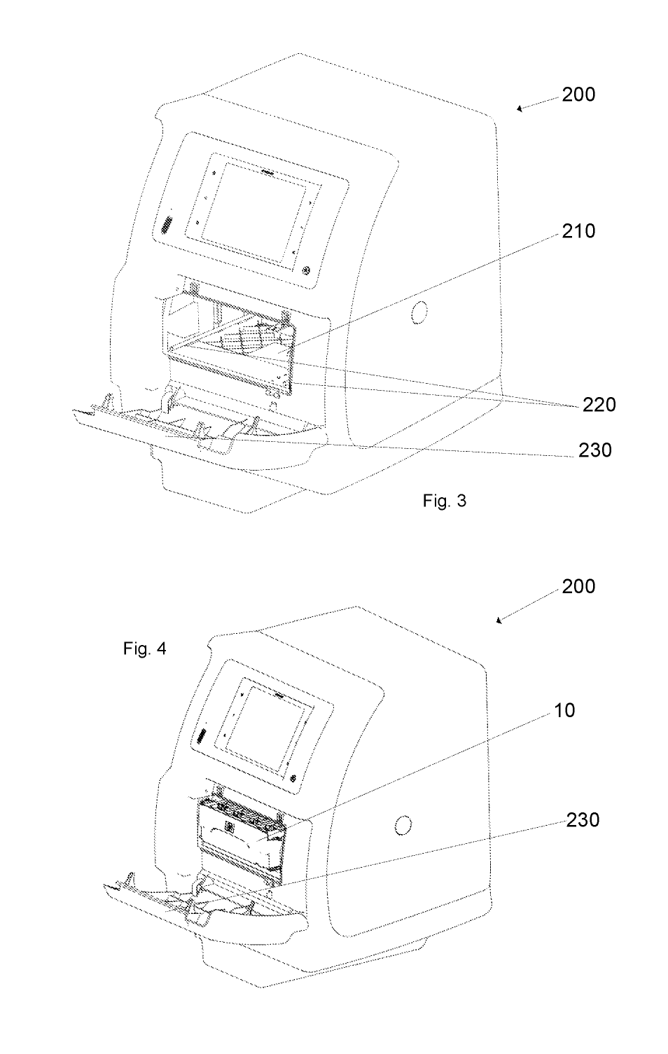

FIG. 1 shows a print head servicing unit in the form of a replaceable cassette 10, which is insertable in a matching docking receptacle 210 (FIGS. 3 and 4) in a hard copy apparatus or device 200 such as an ink-jet printer.

The cassette comprises a substantially cuboidal housing 12 of plastics material. The housing comprises a base 14, end walls 16, 18, side walls, and a top cover 30. Top cover 30 has an opening 32 extending across the width of the cassette in which are mounted roller elements 42, 44 and 46 also extending across the width of the cassette.

The roller elements 42-46 serve for the guidance of a web member 50 of absorbent material through the cassette. The web is initially wound on a first spool 52, which is a feed spool. The spool is arranged to supply clean web material to roller element 42, from which it passes over a pivoting wiper rocker member 60, extending across the width of the cassette. Member 60 is arranged to pivot around a bar element 64. Springs 66 are provided in the cassette and are configured to exert a biasing force on the member 60.

From here, the web member 50 passes beneath roller element 44, over bar element 64 and then beneath roller element 46. As it passes over rocker member 60 and then over bar element 64 it is exposed to the exterior of the cassette.

From roller element 46, the web material passes along to a further roller element 62 and then downwardly to a second spool 72, arranged to receive used web material. Spool 72 is a take-up spool and is arranged to be rotated by means of a gear wheel mechanism 84 driver via an input gear wheel 86.

Spool 52 is located in a relatively small compartment 74 of the cassette 10, whereas spool 72 is located in a relatively large compartment 76 comprising a space 78 directly surrounding the spool 72 and a space 80 in communication with space 78 and extending along the length of the cassette beneath the feed spool 52.

The material of the web 50 is a plastic mesh which is impregnated with polyethylene glycol (PEG). This is effective for use with hard copy devices using latex ink.

Located towards one end wall 16, of the cassette is an array of print head caps 90, in the form of rubber shells. These are positioned so as to correspond to the disposition of the print heads of a hard copy device with which the cassette is to be used, as described later.

Located towards the other end 18 of the cassette is an array of rectangular openings 82. These are positioned so as to correspond to the disposition of the print heads of the associated hard copy device.

Located at the end 18 of the cassette is an aerosol filter 100 in communication with the exterior of the cassette and arranged to trap particulate material from the atmosphere in the vicinity of the print heads of the hard copy device. In particular, the space 130 between the top cover 30 including the openings 82 and the web region 50b has channels 140 leading to the filter 100.

End wall 16 has a handle element 110 to enable the cassette to be pulled out of an associated hard copy apparatus.

As supplied, the cassette 10 has a feed spool 52 full of clean web material 50. A length of web material extends through the cassette along the previously-described path and is already attached to the take-up spool 72 which is substantially empty.

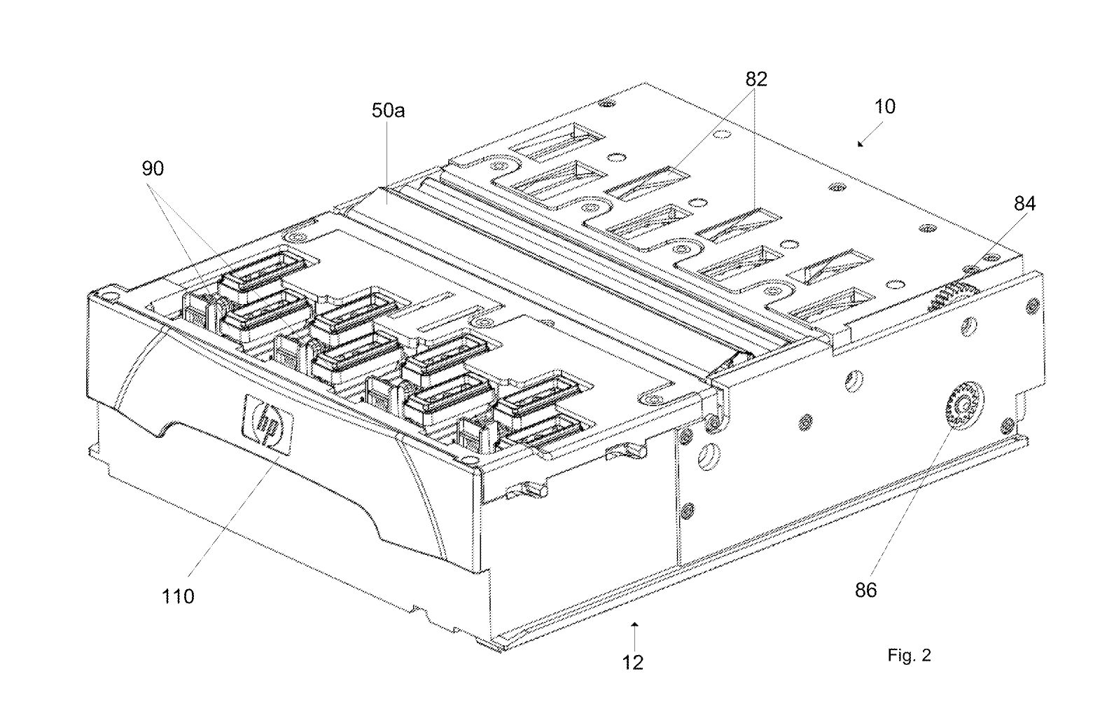

In use, if there is a used cassette already in the hard copy device 200, this is first removed from the docking receptacle 210 and appropriately disposed of or recycled. Cassette 10 is then inserted, by sliding it on two slider rods 220. The docking receptacle of the hard copy apparatus has a door 230 which is latched in a closed position behind the cassette. The cassette is thus held in place in the receptacle. The print heads of the hard copy device have a path of movement in the device and the cassette is located at one end of the path of movement. The print heads move from left to right and from right to left in FIGS. 1 and 2, ie from the front to back and vice versa of the printer shown in FIGS. 3 and 4.

When the cassette 10 is inserted in the hard copy device 200, it automatically connects up to certain mechanisms of the hard copy device. In particular, filter 100 is automatically aligned with a suction path leading to an aerosol extraction fan within the hard copy device. This enables the filter to filter out particles produced during printing and servicing operations, the particles travelling through space 130 and along channels 140.

In addition, gear wheel 86 of take-up spool 72 is connected to a drive mechanism of the hard copy device, which is capable of advancing the web 50 as and when required.

The cassette is capable of performing a number of different servicing or maintenance operations as will now be described.

Capping

To cap the print heads of the hard copy device, for example during prolonged periods of non-use, they are moved by a print head drive mechanism thereof into alignment with the caps 90. The print heads have respective nozzle plates and, upon lowering of the print heads on to the caps, the caps seal against the nozzle plates to prevent drying thereof.

Wiping

In some printers, rubber blades are used to wipe used print heads. Such a cleaning procedure can be ineffective when ink has dried or partially cured on the print head nozzle plate. This is often a problem in connection with latex ink based hard copy devices, where it is possible for crusts to form. There is often a provision for the collection and removal of accumulated waste products. The present embodiment uses web 50 to wipe used print heads and in particular a region 50a of the web where it is configured to project slightly out of the housing 12. This region 50a is in the vicinity of rocker member 60, the region constituting a first operating location. In a wiping operation, the print heads are moved to a position over region 50a and then lowered into contact with the web. Springs 66 cause member 60 to urge web region 50a against the print heads. The print heads are then caused to undertake a slight horizontal movement to effect a wiping action thereon by the web. The print heads are then raised away from the web.

Before each wiping operation, a check may be made whether region 50a is already too soiled, in which case the web 50 is advanced by a corresponding rotation of spool 72 by the hard copy device drive mechanism causing gear wheel 86 to rotate. Alternatively, the web 50 may be so advanced before every wiping operation.

Spitting

Some hard copy devices produce so little waste ink that the ink waste products can be retained within the device throughout its working lifetime. This can be within a foam member and/or within a compartment in the device. Where greater volumes of waste ink are produced, a corresponding container is provided, which is periodically drained and/or removed in a maintenance operation.

Print head nozzles which have not been fired for some time need to be spat in order to restore the fluidic path from the inside of the print head to the outside, through fluidic channels and chambers, taking out particles and small clogs.

The present embodiment uses web 50 to receive material which has been spat from the print heads and in particular in region 50b of the web where it is configured to be accessible from the exterior of the housing 12 through apertures 82. The region 50b is located above take-up spool 72, the region constituting a second operating location.

In a spitting operation, the print heads are moved to a position over region 50b in which they are each aligned with a respective aperture 82. The print heads are then actuated to spit ink through the apertures on to the web 50.

As seen in the Figures, the web 50 is gradually advanced from left to right. Accordingly, the part of the web in region 50b at any time has previously been in region 50a. In other words, region 50b is located downstream of region 50a. Thus the web is used for both wiping and spitting purposes. This maximises the use of the absorbent properties of the web material. Although the web material in region 50b is usually soiled to some extent, the volume of ink absorbed in a wiping operation is typically less than the ink absorbed in a spitting operation, so that the absorbent properties of the web material are not overloaded.

The web 50 may be advanced before a spitting operation is undertaken. The web may be advanced during a spitting operation. The web may be advanced after a spitting operation.

Priming

Priming is a type of spitting operation. It involves the flow of a significantly greater volume of ink and is employed, for example, when a normal spitting operation is insufficient to clear a blocked print head. In some printers a special area is provided near to the print head caps to receive such volumes of ink.

The present embodiment uses the same region 50b to receive ink ejected from the print heads in priming operations. If desired, the web is advanced more frequently or by greater amounts for a priming operation.

Aerosol Extraction

When ejecting ink, print heads tend to produce a so-called “aerosol” of air-borne ink droplets and particles of components of the ink in a form of spray. To prevent the possibility of this spray reaching the print media and possibly producing a deterioration in print quality, some hard copy devices have an internal fan which produces suction to drive the aerosol through a filter. Where small volumes are produced, the filter may not be replaceable. For larger aerosol volumes, a replaceable filter is provided within the printer or within an associated module. This filter is replaced as an individual operation.

The present embodiment has an aerosol filter 100 which is connected at its input side to channels close to the region 50b of the web. Suction is applied to the channels and through the filter by means of a fan located within the hard copy device.

Waste Storage

As mentioned above in connection with the spitting operation, some hard copy devices have a waste ink container which periodically requires an individual maintenance operation.

The present embodiment has a spacious compartment 76 for receiving waste ink. As the web material is wound up on take-up spool 72, ink may be squeezed out of the material of the web into a surrounding space 78. As further ink accumulates, the ink waste also flows into adjacent space 80. The spaces 78 and 80 forming compartment 76 are located within the cassette housing 12. In total they form a volume of approximately one litre. For a typical latex ink based printer this suffices for approximately one month of normal operation.

Removing and replacing the cassette 10 is a simple operation. The cassette may be replaced when the web 50 is fully or nearly fully wound on take-up spool 72. The cassette may be replaced when the compartment 76 is fully or nearly full of waste ink product. The cassette may be replaced when the air filter has reached or has nearly reached its capacity. The length of the web 50 and the capacity of the air filter 100 are matched to each other and to the capacity of compartment 76 such that all three approach their limits at approximately the same time with normal operation of the hard copy device. An advantage of the described arrangement is that all the servicing components, in particular the caps 90, the web 50, the filter 100 and the ink waste storage compartment 76 are replaced in a single operation. Thus cassette 10 constitutes a single “consumable” instead of separate consumables for the various components for handling waste ink materials. It is compact and provides an integrated liquid waste receiving and storage solution which is quick, clean and convenient to use.

The web 50 is immediately ready for use after insertion of the cassette 10 into the hard copy device. The web 50 already extends between spools 52 and 72 so that a user does not need to thread the web through the unit along its path before use. The web can be immediately advanced past the print head.

Another advantage of the described arrangement is that the same component, namely the web 50, is used to receive ink produced both in print head wiping and spitting operations.

By having the take-up spool 72 arranged within space 78 forming part of waste ink compartment 76, the need is avoided for transporting the waste ink.

Various modifications may be made to the above-described arrangement. For example, in one modification the caps 90 may be omitted from the cassette 10; in this case the caps are part of the hard copy device as disclosed in U.S. Pat. No. 8,118,392. In another modification, aerosol filter 100 is omitted from the cassette 10. In a further modification, the cassette does not have a storage compartment 76 for waste ink; in this case either the capacity of the web 50 wound on spool 72 is sufficient to retain all the waste ink or a duct is provided to transfer waste ink from the cassette to the container which is provided on or in the hard copy device. In other modifications, the web 50 is arranged to participate in only a wiping function or only a spitting function; in these cases the other functions can be undertaken by a component which is part of the hard copy device; the web 50 may be omitted completely.

Two of the above-desired modifications can be combined.

In another modification, the above-described cassette has an aerosol filter 100 which is individually replaceable. This is of advantage in cases where the required replacement rate of the fitter differs from the other components of the cassette.

The above-described arrangement is particularly suitable for latex ink based printers, since these produce a relatively high volume of waste ink which has a tendency to solidify and form unwanted crusts. Thus the all-in-one arrangement provided by the above-described cassette is advantageous because it integrates the servicing functions and minimises ink waste transport. However, the hard copy device may use other types of ink and other types of absorbent fabric material for the web 50 may be selected accordingly. The term “ink” is defined to also include other imaging materials and other fluids which can be ejected by a hard copy device including fixing fluids.

The cassette 10 can be used with inkjet or other types of printer. It can also be used in connection with other types of hard copy devices including plotters, photocopiers, facsimile machines and scanners, and devices undertaking one or more of these functions.

In a modification, instead of spitting ink on a region of the web 50 which has already been used for wiping, it may be arranged that spitting is affected on a clean region of the web.

Spools 52 and 72 may be replaced by other suitable web feed and web take-up devices.

The roller elements 42-48 and 62 may rotate or may be fixed elements with smooth cylindrical surfaces.

The caps 90 may have a driving mechanism for moving them relative to the print heads in a capping operation.

During a wiping operation, the web 50 may be moved instead of the print head to effect wiping.

Preferred embodiments of the present invention comprise a print head servicing unit which is capable of being attached to and detached from a hard copy apparatus with at least one print head, the unit comprising two or more of the following components:

(i) a movable web member of absorbent material for receiving waste ink from the print head;

(ii) a storage compartment for accommodating received waste ink;

(iii) a cap for the print head;

(iv) a filter for filtering air-borne particles in the region of the print head.

The movable web member can be arranged to wipe ink from the print head and to receive ink spat from the print head. The web member can be arranged to receive spat ink at a region thereof which is downstream of a region thereof which is used to wipe ink from the print head. The movable web member may extend from a feed device, through at least one part of the unit where it is accessible from the exterior of the unit, to a take-up device. The take-up device may be located in said storage compartment.

Preferred embodiments of the present invention comprise a print head servicing unit which is capable of being attached to and detached from a hard copy apparatus with at least one print head, the unit accommodating a movable web of absorbent material which extends from a web feed device past an operating location to a web take-up device, the arrangement being such that, when the unit is attached to a hard copy apparatus with the operating location adjacent to the print head, the web is immediately capable of being advanced past the print head. The movable web may be disposed so that a first region of the web is arranged to wipe ink from the print head and a second region of the web, located downstream of said first region, is arranged to receive ink spat from the print head. The unit may comprise a compartment for receiving and storing waste ink, and the web take-up device may be located in said compartment. The unit may additionally comprise a cap for the print head and a filter for filtering air-borne particles.

Preferred embodiments of the present invention comprise a method of servicing the print heads of a hard copy apparatus comprising inserting a print head servicing unit in the hard copy apparatus, the servicing unit being capable of performing a plurality of different servicing operations on at least one print head of the apparatus, and, after using the unit to perform a plurality of servicing operations on the print head, removing and replacing the unit, the different servicing operations comprising two or more of the following:

(v) receiving waste ink from the print head;

(vi) accommodating received waste ink in a storage space within the unit;

(vii) capping the print head; and

(viii) filtering air-borne particles.

Although the present disclosure has been described with reference to certain embodiments, workers skilled in the art will recognize that changes may be made in form and detail without departing from the spirit and scope of the claimed subject matter. For example, although different embodiments and modifications may have been described as including one or more features providing one or more benefits, it is contemplated that the described features may be interchanged with one another or alternatively be combined with one another in the described embodiments or in other alternative embodiments.

1. A print head servicing unit which is capable of being attached to and detached from a hard copy apparatus with at least one print head, the unit comprising:
(i) a movable web member of absorbent material for receiving waste ink from the print head from each of a wiping operation, a priming operation and a spitting operation;
(ii) a storage compartment for accommodating received waste ink;
(iii) an array of caps for the print head; and
(iv) a filter for filtering air-borne particles in the region of the print head.

2. (canceled)

3. A unit according to claim 1, wherein the web member is arranged to receive spat ink at a region thereof which is downstream of a region thereof which is used to wipe ink from the print head.

4. A unit according to claim 1, wherein the movable web member extends from a feed device, through at least one part of the unit where it is accessible from the exterior of the unit, to a take-up device.

5. A unit according to claim 4, wherein the take-up device is located in said storage compartment.

6. A print head servicing unit which is capable of being attached to and detached from a hard copy apparatus with at least one print head, the unit accommodating:
a movable web of absorbent material which extends from a web feed device past an operating location to a web take-up device, the arrangement being such that, when the unit is attached to a hard copy apparatus with the operating location adjacent to the print head, the web is immediately capable of being advanced past the print head, wherein the movable web is disposed so that a first region of the web is arranged to wipe ink from the print head and a second region of the web, located downstream of said first region, is arranged to receive ink spat and primed from the print head;
a storage compartment for receiving waste ink received by the movable web;
an array of caps for the print head; and
an air filter for filtering aerosols in the region of the print head.

7.-8. (canceled)

9. A unit according to claim 6, wherein the web take-up device is located in said storage compartment.

10.-11. (canceled)

12. A method of servicing the print heads of a hard copy apparatus comprising inserting a print head servicing unit in the hard copy apparatus, the servicing unit being capable of performing a plurality of different servicing operations on at least one print head of the apparatus, and, after using the unit to perform a plurality of servicing operations on the print head, removing and replacing the unit, the different servicing operations comprising:
(i) receiving waste ink from the print head from a r in e ion;
(ii) wiping waste ink form the print head;
(iii) receiving waste ink from the print head from a spitting operation;
(iv) accommodating received and wiped waste ink in a storage space within the unit;
(v) capping the print head; and
(vi) filtering air-borne particles.

13. A method according to claim 12, wherein the unit comprises a movable web member of absorbent material and wherein receiving waste ink from the print head comprises using a first region of the web member to wipe ink from the print head, and using a second region of the web member to receive ink spat and primed from the print head, the second region of the web member being located downstream of the first region.

14. A method according to claim 12 wherein the unit comprises a movable web of absorbent material which extends from a web feed device past an operating location to a web take-up device whereby, after insertion of the unit into the hard copy apparatus, the web is immediately capable of being advanced past the print head.

15. A method according to claim 14, wherein the web take-up device is located in said storage space.
